(19) United States
(12) Patent Application Publication
(10) Pub. No.: US 2010/0180931 A1
(43) Pub. Date: Jul. 22, 2010

(54) Solar Power Equipment for the Industrial Processing of Various Materials Through the Utilization of Solar Energy

(76) Inventor: Gábo Göde, Budapest (HU)

Correspondence Address: WILLIAM D. HARE, 66 WITHERSPOON STREET, STE. 1, PMB 317, PRINCETON, NJ, 08542-9944, US

(21) Appl. No.: 12/667,503

(22) PCT Filed: Jul. 31, 2008
(86) PCT No.: PCT/HU08/00094

§ 371 Date: Dec. 31, 2009

(30) Foreign Application Priority Data
Aug. 1, 2007 (HU) HU P 0700502

(51) Int. Cl. H01L 31/052

(52) U.S. Cl. 136/246

(57) ABSTRACT

Solar power station for processing various materials by solar energy with a parabolic collector provided in its focus with a receiver, fixed in a manner enabling its free rotation at least in two directions around the shaft at its convex side, of a double shell structure comprising arched segments clamped to a grated frame structure adjustable to follow the direction of sunshine, provided with supporting and moving elements where it contains a heat receiver developed as a processing working space, and is connected to material storing units and the conic receiver (7) of the collector (1) comprises a conic internal cavity the wall of which and the parallel external wall of the receiver (7) enclose another internal cavity furnished with material transporting structures, and serves as a processing working space for processing various materials by heat energy, further one of the material storing units (25) of the calotte (2) belonging to the collector (1) is connected by an ascending pipeline (64) provided with a pump to the material processing working space (31) in the receiver (7) of the collector (1), and from this working space another, descending pipeline (65) leads into another material storing tank (26) placed in the calotte (2).

The invention relates to a solar power equipment for the processing of various materials at very high temperatures.

The invention is an expediently designed processing unit for chemical and physical transformations of various materials to be processed at very high temperatures and for other types of their processing by the equipment comprising a parabolic collector of a double shell structure formed by arched segments clamped into a grated frame structure with a receiver in its focus, adjustable to follow the direction of sunshine which is fixed in a manner enabling its free rotation at least in two directions around the shaft at the convex side, and it is provided with supporting-moving elements where it contains a heat receiver, and the whole structure is connected to a storage unit.

There are several solutions for the large-scale utilization of solar energy. The essence of the known photoelectric (photovoltaic) process is the generation of electric current by incident sunshine in solar elements acting as semi-conductors. The advantage of this system is the direct generation of electric current. Its disadvantage is—due to which it cannot be used competitively for energy production at large-scale—that the solar elements are made of very expensive silicon single crystals which are very difficult to produce at the large scale, or of polycrystalline silicon of less efficiency. Another draw-back of these methods is their low efficiency and their short life-time.

In another type of equipments utilizing solar energy, in flat collectors, in a pipe system situated in the flat screens, water is circulating exposed directly to sunshine which water, when heated, can be used directly in households.

The highest efficiency of solar energy conversion in photovoltaic equipments is approximately 9-11%, whereas the same value for flat collectors makes about 30%.

The importance of solar energy concentrating equipments is based on the high temperature which can be reached by means of optical concentration of solar energy with a theoretical upper limit of 6000° C. 2800° C. has been already reached in experimental establishments. This concentration can be achieved by a suitable geometric arrangement of mirrors, and by the sun-following movement of the collector mirrors. The main types of sunshine collecting (concentrating) equipments are: parabolic and cylindrical parabolic collectors, spherical mirrors and Fresnel-lenses. Compared to systems utilizing flat collectors, these latters are more economical, since their efficiency increases with increasing concentration and temperature of the heat source. By a better thermodynamic utilization of thermal energy, higher specific thermal technical power can be achieved.

However, solar power stations operating on the Fresnel-principle, apart from their several advantages, have also some disadvantages as well, e.g. they have a large area demand (3-7 km²), thus the distance between the heat receiving column and the heliostats is quite considerable (maximum 2-3 km).

Another of their disadvantages is that the intensity of the thermal and light rays reflected from the mirrors is significantly reduced by the temperature of air, by air circulation and by the shielding effect of dust particles floating in the air. As the reflected rays pass through the air, air acts as an energy absorbing, cooling medium, and this effect is increasing very intensely with increasing distance.

The majority of investment costs will fall to the big tanks serving as heat storage instruments, the expensive condensation equipment and the column.

Even another disadvantage of these solar power stations is that since a sun-following movement of the heat receiver installed in the center of the heliostat field cannot be solved, in case of the majority of mirrors, when they are set to follow the sun, only a smaller part of the area of the mirror can be utilized than the real surface of the mirrors due to the fix position of the column, in contrast to the parabolic sun-following mirrors being a body of rotation, in which case the mirror surface can be much better utilized.

A further disadvantage of these solar power stations is that they are usually located in the desert, where there is no sufficient water supply for condensation, thus heat extraction (condensation) can be performed only by air cooling requiring considerable electric power and being less effective.

The aim of the present invention is to eliminate these disadvantages of the existing solutions, and to design an equipment requiring the smallest possible area of dry land or only area covered by water, in which the distance between the reflecting surface and the heat receiver is only a small part of the distance in traditional solar power stations, and the heat receiver is designed so that it is suitable for the high temperature processing of various materials at large scale, in which there is no need for a column, and by this and by decreasing the size of the heat storing tanks, or by substituting them by their cheaper versions, significant costs can be saved at an equal capacity. The purpose was also to design an equipment which can be settled onto water, and which is provided with suitable protection against wind load and the rolling sea.

The task is solved by an equipment which comprises a parabolic collector with a receiver in its focus, fixed in a manner enabling its free rotation at least in two directions around the shaft at the convex side, having a double shell structure, composed of arched segments clamped into a grated frame structure, furnished with supporting-moving elements and a heat receiver, and it is connected to a power conversion and a storage unit.

The invention is based on the principle that the supporting and moving structure of a large parabolic collector (100-300 m diameter) can be constructed much simpler if the collector is of a light structure, transport and settling can be solved more easily if the structure is built of elements of panel moduls to be installed on site. Settling the parabolic collector onto water means an advantage for the supporting-moving structure. In case of locating the current generating system onto water, the cooling agent needed for condensation is available in an unlimited quantity. Another advantage of settling onto water is that the significant weight of the huge collector is kept by the elevating power of water, thus instead of an expensive, very strong supporting structure of gigantic size, a much smaller and cheaper structure is applicable, and in this way, the protection against a storm is also solved.

In the equipment according to the invention, the supporting-moving elements are telescopic elements rotable to every direction and connected to the collector at equal distances from each other along an annulus being in a parallel plane to the rim of the collector, with their other end connected to a base in a rotable manner in each direction, surrounding a main support of telescopic type fixed to the base at the lower end, supported by a ball-and-socket joint unilinearly with the rotation axis of the collector. The telescopic elements and the telescopic main support are preferably of hydraulic operation. At the external surface of the collector there is a second body of rotation—preferably a hemisphere or a calotte of a smaller surface than that of the former—is designed in an axially symmetric manner, where in the space surrounded by the collector and the calotte there is a reinforcing structure, whereas the telescopic main support is connected to the calotte in the common centerline of the calotte and the collector. It is preferable to provide the telescopic main support and the telescopic moving elements with a hydraulic control unit connected to an electronic control system.

In one embodiment the collector is placed onto a water surface of regulated level so that the base is under the water level, whereas the rim of the collector is in its every position above the water level. From the outside, at its eastern and western sides, the collector is preferably provided with air bags divided into spaces separated from each other by means of partition walls. The water surface of a regulated level is surrounded by a barrier with sluices and wind baffle elements thereon, where the wind baffle elements are connected to the barrier in a fixed way, or by means of a telescopic moving element.

More solar collectors forming a solar power station can be placed onto the water surface of a regulated level surrounded by a barrier with sluices on it.

By the application of this solar power station, various materials requiring very high temperatures for their processing can also be processed at large scale. Another embodiment of this equipment comprises an energy transformer provided with a lower water storage tank being under the high tide water level, and with an upper storage unit above the natural water level. Elements of the receptor and those of the working space for processing of various materials can be placed into the receiver, whereas the storage tanks provided with insulator layers can be located in the calotte.

The power generating variant of the solar power station has a supplementary function, namely, to provide the solar power station with electric current and thermal energy in case of a temporary overclouding. For this task, the preferable solution is to use equipments operating according to the Brayton-type gas cycle in the receiver of the parabolic collector. In case of applying the Brayton-type gas cycle, the energy transforming system consists of compressing, preheating, gas heating and turbo-generator units.

The collector is constructed from arched units consisting of a rib-frame made of double, arched rib elements. The external and internal rib-frames are connected by distance panels, the space confined by the double arched rib-elements and the distance panels is filled with a multilayer grate structure with connecting elements fixing the layers to each other. At the external part, the grate structure is closed up by casette elements fitted to the rim of the rib elements, whereas the rims of the casette elements and the surfaces of the connecting elements are closed by means of flexible plastic strips provided with some adhesive on their one side. The raw material of the casette elements is preferably an artificial resin reinforced by carbon fiber or textile glass, and they are glued together. At the internal part, on its concave side, the collector is covered by reflecting plates directed to the focus of the collector, preferably made also of artificial resin reinforced by carbon fiber or textile glass, which are clamped at the internal surface of the collector by means of adjustable spring screw fixing units through the borings made into the rib elements, or are provided with a sun-following moving structure.

The solar power plant equipment with its huge energy collecting surface is particularly suitable—especially if it is settled under tropic climate or in other area of intense sunshine—for producing permanently very high temperatures by collecting huge amounts of thermal energy and reflecting it concentrated to an energy receiver of specific form containing a processing unit, enabling the carrying out large scale chemical processing of materials requiring large amounts of energy in a cost-efficient, environment-friendly way.

Until now, by the application of presently available equipments, no high temperature processing of various materials at industrial level have been performed by utilizing solar energy, except for producing hot water, electric energy and heating.

In France, melting of metals with high melting point was performed by arched sun mirrors under laboratory conditions, however, this was possible only for small amounts of metals.

The solar power station according to the invention is especially important and energy-saving in preparing reactive metals from their ores, or at the reduction of suitable metal oxides for obtaining hydrogen, further on in high temperature processing of the raw materials in alumina or cement production.

As a possible field for the application of the solar power station according to the invention we want to show the large scale production of hydrogen.

Hydrogen is present on Earth in largest amounts in its simplest compound, water. Hydrogen, as the most general energy carrier in the future, is especially suitable for production of energy when burnt in power plants, vehicles, power machines and delivery vans taking over thereby the place of petroleum derivatives. Its clean burning being free of harmful materials, its three-times higher thermal value as compared to gasoline, its presence on Earth as water in an unlimited amount, make hydrogen an energy carrier most important for the survival of mankind.

In spite of all these advantages, at present, the general spreading of the use of hydrogen is hindered by its very high production cost. At industrial scale, hydrogen is produced at present by the water-gas reaction, or by reforming of natural gas, which processes are not only very energy-demanding and thus very expensive, but they also require the use of large amounts of not recuperative, expensive energy carriers. Another disadvantage is that these hydrogen producing processes have a very high emission of harmful materials. These problems necessitate the introduction of cheap hydrogen-producing equipments and processes free of harmful emission, as soon as possible. At the same time, electrolysis of water requires expensive electric current, this is why this process is used for preparing only small amounts of hydrogen.

By the utilization of solar energy, new processes were born for producing hydrogen.

For the production of hydrogen by water electrolysis or other methods by utilizing solar energy, following patents can be found.

The Japanese patent application JP 198001 15679 19800822 provides a solution mainly for storing energy by forming metal hydrides. According to the application, hydrogen is produced by water electrolysis using the electric energy produced by photovoltaic solar cells or by power plants utilizing the energy of wind or waves. This equipment and process are not suitable for producing hydrogen at the large scale, in industrial amounts due to the high cost.

The U.S. Pat. No. 4,161,657 describes a composite system, in which the equipment reacts to the changing radiation energy, which is transformed into electric current, then hydrogen is produced again by water electrolysis by utilizing this electric energy. Neither this hydrogen producing system is applicable for the production of large amounts of hydrogen.

The German patent application DE 20031018036 20030419 describes a base floating on water which rotates to the sunshine and comprises photocells with concentrating lenses and an integrated electrolysis equipment. This equipment is not protected against storms, and is capable of producing only small amounts of hydrogen.

The Japanes patent application JP 2002333054 20021118 provides an equipment for hydrogen production from the moisture of the atmosphere. This is an equipment producing hydrogen of high purity by using hibrid electric energy for water electrolysis. However, neither this equipment is suitable for producing cheap hydrogen in large amounts.

The US patent application US 19780948061 19781002 describes an apparatus in which the sun reflector concentrates the solar energy for reaching the temperature of water decomposition in a chamber containing the water. Hydrogen and oxygen obtained are taken out separately. It is not probable that according to this description and the figures enclosed, the temperature of about 2000° C. needed for water decomposition could be reached. On the other hand, it is not clear how the tank can tolerate the huge vapor pressure. Even in the case the above conditions are fulfilled, this solution cannot be economic, as the apparatus is capable of producing only small amounts of hydrogen.

The Bulgarian patent application BG 19990103424D 1999 0521 describes the use of catalysts for the production of hydrogen, such as chlorofil and superoxidimutase obtainable directly from plants and animals. Though the idea is imposant, the implementation is very costly, as the equipment would operate with a very low efficiency and would necessitate the building of very expensive equipments.

The German patent DE 20001011557 20000309 provides an equipment in which a solar panel heats the water, and water is ascending and distributed in several vertical pipes as the result of heating. As the water is cooled down in the pipes, it descends and goes through a very narrow pipe exerting thereby a pressure driving a high pressure water turbine and a generator. It is not clear from the description, how the apparatus produces hydrogen. The low efficiency of the equipment—if it would be capable of producing hydrogen at all-would make the production of large amounts of hydrogen impossible.

The Japanese patent 200101011160 20010330 describes a system providing oxygen and hydrogen by using an equipment floating on the sea surface far from the shore. It comprises a chamber absorbing solar energy in order to produce vapor for evaporating the sea water. The vapor drives a turbine and a generator producing electric current and this current decomposes water in order to obtain hydrogen and oxygen. Protection against storm is not solved, and it is doubtful whether without having an equipment for concentrating solar energy, it would be able to produce vapor of high temperature and pressure. This solution, if it were operative, could produce also only small amounts of hydrogen in an expensive manner.

The U.S. Pat. No. 4,071,608 describes an apparatus in which the solar energy is reflected to a water tank by a sun reflector in order to produce water vapor. The vapor either drives a turbine and a generator for the production of electric current, or it is led into a water decomposer in which the vapor decomposes to hydrogen and oxygen by hitting against the heat transfer surface owing to the effect of centrifugal force. This equipment, if it would be working at all, would provide only small amounts of hydrogen due to the size of the concentrating mirror, if the temperature of 2000° C. needed for the thermal decomposition of water could be ensured continuously.

Neither of the patents described here fulfills the requirements of producing hydrogen at the large scale in industrial amounts, at a low price, neither show they any resamblance to the equipment and procedure according to this invention.

One of the aims of the present invention is to eliminate the shortcomings of the equipments and processes described, to solve thereby the most economic production of hydrogen at large scale, in industrial amounts from water available in unlimited quantity, using pure metals obtained from suitable reactive metal oxides by reduction as mediating material, where the reduction of the metal oxide is performed by the huge amount of high temperature, concentrated thermal energy obtained by utilizing solar energy most economically with the use of a solar power station according to this invention having the largest collecting surface. One of the reactive metals suitable for the mediated production of hydrogen is, among others, zinc (Zn), for the production of which following procedures exist:

The most important zinc ore is sphalerit (ZnS), while its oxide ore is zincite (ZnO). At present, zinc is prepared so that the zinc ore is enriched by flotation, and after the corresponding chemical reaction, the process results in pure zinc powder. It is then smelted in three main steps: oxidative torrefaction, distillation and refining. Torrefaction is performed in a burning oven of several levels or newly, in fluidizing reactors. During burning, the powder is intensively moved in order to avoid coagulation of the particles. After mixing the burnt ore with anthracite, the mixture is placed into the distillers, where the carbon monoxide formed from the anthracite reduces the zinc oxide at about 1000° C. At the end of the procedure the temperature can reach even 1300-1400° C. Another process which can be used is the electrothermal zinc distillation. Zinc obtained by distillation contains still 1-4% of contamination, which can be removed by liquation or fractional distillation.

The receiver of the solar power utilizing equipment according to the invention described in detail later, is suitable for the torrefaction and distillation of the zinc ore. In the latter process, the ore is mixed with anthracite, and carbon monoxide is blasted in for keeping the particles float whereby their coagulation is avoided and, at the same time, zinc oxide is reduced to metallic zinc. Then purification of zinc follows, after which the pure metal can be reacted with hot water or water vapor, in the course of which reaction hydrogen is liberated from the water molecules. The user can collect and utilize this hydrogen. Thus, a cheap production of hydrogen at large scale becomes possible. The zinc oxide remaining back can be transferred into the solar power plant, in the receiver, from which it can be mixed again with anthracite, reduced at the correspondingly high temperature by blasting CO or without this again, and can be utilized again as pure zinc metal. In addition, another possibility is that at the very high temperature produced by the solar power station, aluminum reduces zinc oxide by heat evolution.

A further possibility for producing hydrogen is to develop in a receiver 7 of a solar power station 1, a working space in the form of an ascending pipe coil 18 and capable of ensuring the highest possible temperature needed for thermal water decomposition is developed. Input of water into a vapor production unit 20a occurs in this embodiment via a valve 21b through a pipeline 19a being in a supporter unit 8. The lowest input part of the pipe coil 18 consists of a vapor production unit 20a developed to be pressure resistant, which puts hot vapor of high pressure continuously into the pipe coil 18, in which the water vapor molecules decompose thermally into hydrogen and oxygen at the highest reachable temperature needed for this process. At the end of the pipe coil, a separator 23 separates oxygen and hydrogen, and both gases are led separately through pipelines 65a and 65b into receiver tanks 25 and 26 placed in calotte 2, from where they can be transported via pipelines 27 and 28, or stored in liquefied form until use. The wall of pipe coil 18 is made of a metal of very high melting point and resistant to high pressure.

In another possible embodiment, parallel to the inner wall 29 of the working space and closing the inner cavity of the receiver, in a given distance, the outer wall of a calotte-like working space 30 is also made of a metal with high melting point and pressure resistance. The receiver body thus formed is cylindrical and closed on the upper and bottom side. Water gets into a vapor production unit 20a at the bottom of this receiver via a valve 21b through a pipe 19a being in the supporting unit 8. From this vapor production unit 20a, a valve 22 opening to high pressure lets continuously hot vapor of high pressure into the cylindrical working space 31, where the overheated water molecules decompose to hydrogen and oxygen, which are separated by a separator 23, and are led through pipeline 24 to tanks 25 and 26 in the calotte 2.

Another possible way to utilize the equipment is processing by heating, which is used e.g. in alumina production. The raw material of alumina is bauxite, which should be chased for obtaining alumina (Al₂O₃). The procedure is the following. In the Bayer process, aluminum hydroxide crystals are calcined in a rotating pipe-still at 1200-1300° C. Another method for chasing bauxite is to mix the bauxite with a mixture of soda and lime, heating it at 1200° C., whereby sodium aluminate is formed in this pyrogenic process. In a third method, bauxite can be chased by glowing the mixture of sodium sulphate or calcium oxide with bauxite. From bauxite, by mixing it with carbon and pyrite, at 1500-1800° C. more or less contaminated corundum can be obtained.

Each of the above procedures is very energy-consuming. All the three processes can be realized by the solar energy-utilizing equipment according to the invention, however, the most efficient among them is the Bayer process. Another one is the production of corundum by glowing bauxite with carbon and pyrite at 1500-1600° C. The same process can be applied also to produce alumina, in this case by sintering alumina, corundum can be obtained. The form of the receiver makes all these processes realizable, saving thereby huge energy costs.

Reduction of alumina can be solved also by mixing it with anthracite and glowing the mixture at very high temperature.

Another feasable realization of the equipment according to the invention is in cement production. At present, cement is produced so that the raw materials (lime, clay, marl, sand) are ground in a ball mill, then they go to a tube mill where they become a powder of flour fineness. After milling, the material contains water in amounts of 24-38% or 5-15% depending on the procedure, this sludge gets into the sludge-mixing tank, where the end composition is set by mixing sludges of different compositions. This sludge is then stored in tanks provided with stirrers. In the next step the water content of the sludge is removed, and the powder free of water gets into the glowing equipment. For this purpose, rotating tube-stills are used. Carbon is then mixed to the raw materials for burning of the substance. However, burning results in a significant emission of harmful materials, and the ash formed spoils the quality of cement. In the course of burning occurring at 1450° C., the material rolls along the length of the oven, it dries out, balls and granules are formed, lime is calcined, exo- and endothermal reactions start, the material is sintered, and at the end of the oven it gets to the cooler. The resulting material is clinker, which mixed with gypsum and milled becomes cement.

The shape of the receiver of the equipment according to the invention is suitable for the process of burning. Before the wet sludge gets into the working space 31 of the receptor 7 in the equipment according to the invention, water is removed from it by the evaporation equipment operating by solar energy developed according to another invention of the author, and the powder thus obtained is led into the working space 31 of the receptor 7, where it is burnt out corresponding to requirements. The material stays in the working space 31 of the receptor 7 in which the high temperature needed for burning is ensured, until the burning process is finished. This method has several advantages. First, big amounts of fuel can be saved, second, harmful emission is avoided, and third, the quality of cement is significantly improved by the lack of ash formed by the traditional method from the carbon added.

These tasks are fulfilled so that in the focus of the parabolic collector of the equipment according to the invention, the receiver 7 is made suitable for processing the chosen materials by prescribed technology as follows. The inner wall 29 closing the internal cavity 32 of the conic receiver is developed from a metal of high melting point or from a suitable ceramic material. In a given distance perpendicularly to the inner wall 29, another conic external wall 30 goes parallel to the former, both together enclose a space which is the working space 31 of the materials to be processed.

In another embodiment, the external wall 30 of working space 31 for processing is porous. This serves for the removal of gases and vapors formed in the working space into external space 33. In the working space 31 between the two walls of conical geometry mentioned, a conveyor is situated consisting of a scroll system 35 with spirally arranged scroll plates of ever decreasing diameters, driven by an electric engine 34 fixed to supporting unit 8, for transporting the material to be processed in an ascending way into the tank 36 developed at the top of the space of conical geometry.

The bottom part with the largest horizontal scroll plate diameter of this material transporting structure of scroll structure 35 is fixed to an annulus 41 provided with toothing on its side. This annulus 41 is supported on a barrel shaped roller bearing 42 situated on supporting unit 8 in a horizontally rotable way, driven by electric engine 34, which rotates together with the scroll system 35 fixed to it.

According to another possible solution, the spreading system developed from scroll system 35 is provided with vertical supporting plates 37 being in suitable distances from each other, and in the vertical plane above them, blades 40 are placed operated by an electric engine and moving in a semicircle forwards and backwards, providing a uniform distribution and transport of the material to be processed, which are fixed to axis 39 rotable in two directions and connected in series by wire rope 38a, which structure makes the uniform distribution on the scroll plates and transport of the stored material to be processed possible. From among these blades 40, every second one is connected separately by a wire rope 38b, and they are moved alternately by the control system relative to the other ones.

In another embodiment, scroll system 35 is fixed to the inner surface of internal wall 29 surrounding working space 30. To the bottom of this scroll system 35, a rail structure 43 is fixed, to which rail system 43, containers 46 are connected by wheels 45a. Containers 46 are drawn by a regulated speed by tooth chains 44a connected to chains 44b in the working space 31 in an ascending way till the conic upper part, and from there downwards till the bottom of the lowest part of the conic space. Filling of empty containers 46 occurs from the buffer tank 47 developed in the upper part of material transporting tube 64 via the input hole of a tube-neck 48. Regulated by the impulses of a photoelectric cell, the closing plate 49 of the input hole is opened, as a result of which the material to be processed flows into container 46. The control unit opens also the swing door 50 rotable in its axis and situated at the hopper of the transporter tube, which opens at filling in, and then after the buffer tank is filled, closes until the next filling.

The base plate 51 of container 46 can be opened or closed. In the lower axis line of base plate 51, at the parallel sides to the course of container 46, there are supporting battens 52, in the center of which axis 53 is suspended by a pin. At the lower end of axis 53 serving for the rotation of base plate 51, a lever 54 of a defined length is fixed, moving vertically downstairs. There is another fixed, prominent lever 56 above the upper, caved input hole of transporting tube 55 horizontally from the inner wall of the internal working space 29, which impinges to lever 54 hanging from axis 53 of base plate 51 of container 46, and by shifting it horizontally, it opens the base plate 41, from where the processed material flows into the caved hole of transporting tube 55, goes through it into tank 26 in calotte 2. On the farthest side of the container 46 from the axis 53 of the base plate 51, in the direction of progress, a fixed ballast weight 57, or a retracting spring is situated, which restores the original position of the base plate by gravitation if the container 46 is empty, closing thus the bottom of the container. At the lower part of the container 46 directing to the ballast weight 57 there is a bolt 58, which hinders the further sinking of the base plate on this side, i.e. it fixes the base plate from this side.

In a further embodiment material transfer occurs so that the scroll system 35 is fixed. At the sides of this scroll system 35 there are notches 35b in which the material transfer system (conveyor) 59a moving on the lower side of scroll system 35 is fixed by lugs 59c provided with rolls. In the middle of the lower part of the conveyor 59c there is a pit in which a gear rack 59b is placed. This gear rack 59b is driven by a cogwheel 60b coupled to an electric engine, whereas above this cogwheel 60b, a freely rotating fixing wheel 61 presses the toothing on the lower side of the conveyor 59a to the cogwheel 60b. Cogwheel 60b drives conveyor 59b from the upper surface of scroll structure 35a over to the opposite, descending lower surface of scroll structure 35a, to the notch structure developed there. The same takes place, only in the opposite way, in the case of the driving and directing system on the bottom of scroll system 35a.

A further solution for material transport is in which a pipe coil 18 is moving helically upwards as an elongation of conveyor 64, which pipe coil 18 functions as a working space for material processing. In this pipe, material is transported by the scroll system 35 operated by a driving engine, or by paddle wheels 62. If necessary, there are also flap valves in the pipeline, which hinder the flow-back of the material to be processed. In case of solid materials, in the pipeline there are also gas separators 63 for removing the gases or vapors formed.

In calotte 2, a tank 25 of suitable size is situated for storing the material to be processed. This tank 25 is connected to the working space 31 in the energy receiver by a pipeline 64 provided with a pump. This pipeline 64, starting from storage tank 25 in calotte 2 gets by ascending to energy receiver 7, where it is connected to the working space through the input hole at the bottom of the porous wall.

Parallel to this ascending pipeline 64, at the opposite side, another, descending pipeline 65 is situated, which pipeline 65 connects a tank 36 being in the upper part of the working space through the output hole in the bottom of tank 36 with the storage tank 26 containing the processed material. Tank 36 in the upper part of working space 31 is fixed to the conical internal wall 29, and is provided with a material transporting paddle 66 driven by an external electric engine 34.

In one embodiment of the present invention, in the inner part of one of the supporting units 8 for the energy receiver, a pipeline 19 is developed progressing to energy receiver 7 for the inlet of the gas needed for processing. This pipeline 19 is connected to working space 30 between the internal wall of receiver 7 and the external wall 30 of the working space by small connecting tubes of ever decreasing diameter getting on helically upwards via input holes 19a at the external wall of working space 30.

At the opposite side of the inlet tube 19, at the bottom of the space between the internal wall of the jacket of receiver 7 and the external wall of working space 30, to the hole to be found there, a gas outlet tube 19b is connected, going to the rim of collector 6 in the supporting unit 8 of the receiver 7. This tube 19b is provided with a ventilator at its inlet site for removing the gases and vapors formed in the working space during processing. The gas outlet pipe is situated in the inner part of supporting unit 8, and it continues on the external side of rim 6 of the uppermost annulus of the parabolic collector, to which a flexible pipeline is connected leading above the water surface to the tank standing on a socket.

In another embodiment no pipeline 19 is developed in the receiver for the inlet of gases. However, outlet pipe 19b is present also in this embodiment.

In order to minimize the emission of heat, the conical wall of the receptor, i.e. the internal side of the external jacket wall is insulated by a very good insulator developed for high temperature and of good efficiency, preferably by some ceramic insulator.

In calotte 2 being at the lower, external part of the axis of the parabolic collector one or two tanks are to be found for storing the material processed or to be processed, these tanks are fixed to supporting structures 68a in calotte 2, either in a fixed way, or by inserting springs or shock absorbers. The tanks are connected to receiver 7 by inlet pipes 64 and outlet pipes 65. The tanks are provided also with other in- and outlet pipes. These are inlet pipes 27 and outlet pipes 28, which lead through the wall of calotte 2 and they are fixed to collector 1. They lead several meters above the water surface, and from there, they continue in preferably flexible pipe-ends provided with valves or pins. To these pipe-ends provided with some connecting units, the rigid or flexible pipe-ends of tankers 70 provided with connecting elements can be linked. The pipelines of tankers 70 mentioned, lead in- or out of the storage tanks of the tanker for materials processed or to be processed.

The invention is shown in detail on the drawings attached on basis of embodiments serving as examples:

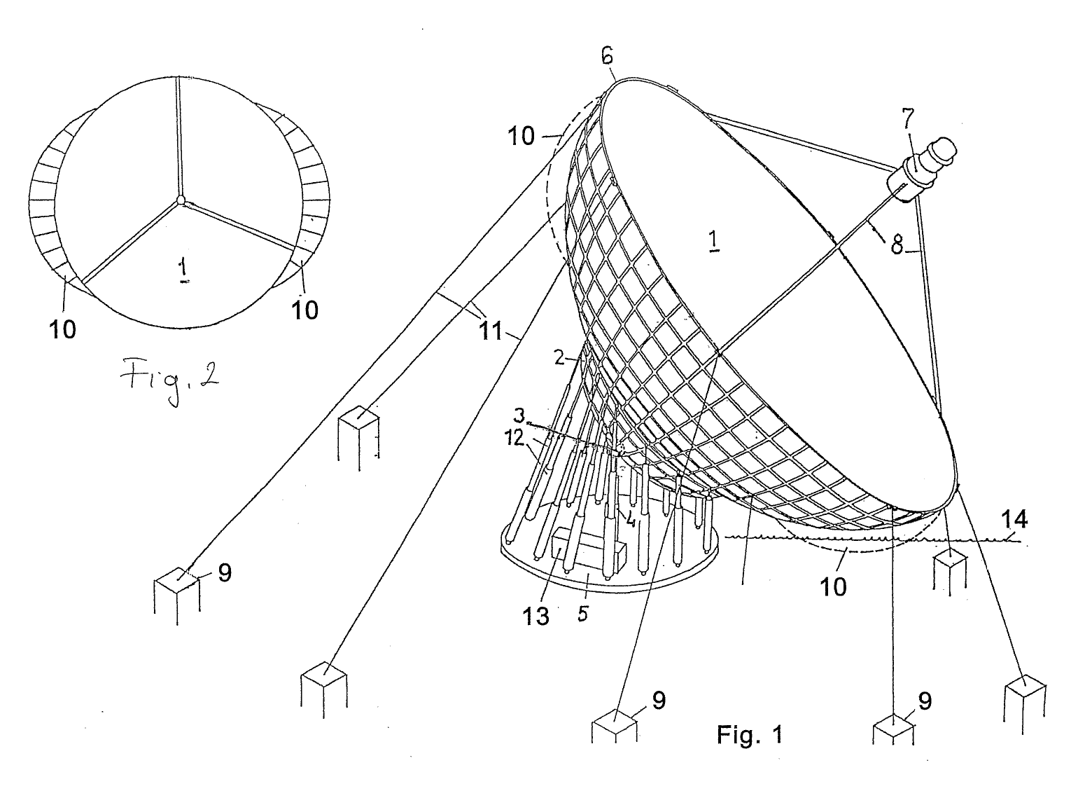

FIG. 1 shows the equipment according to the invention in its embodiment settled onto water,

FIG. 2 shows the top view of positioning air bags in the embodiment shown in FIG. 1,

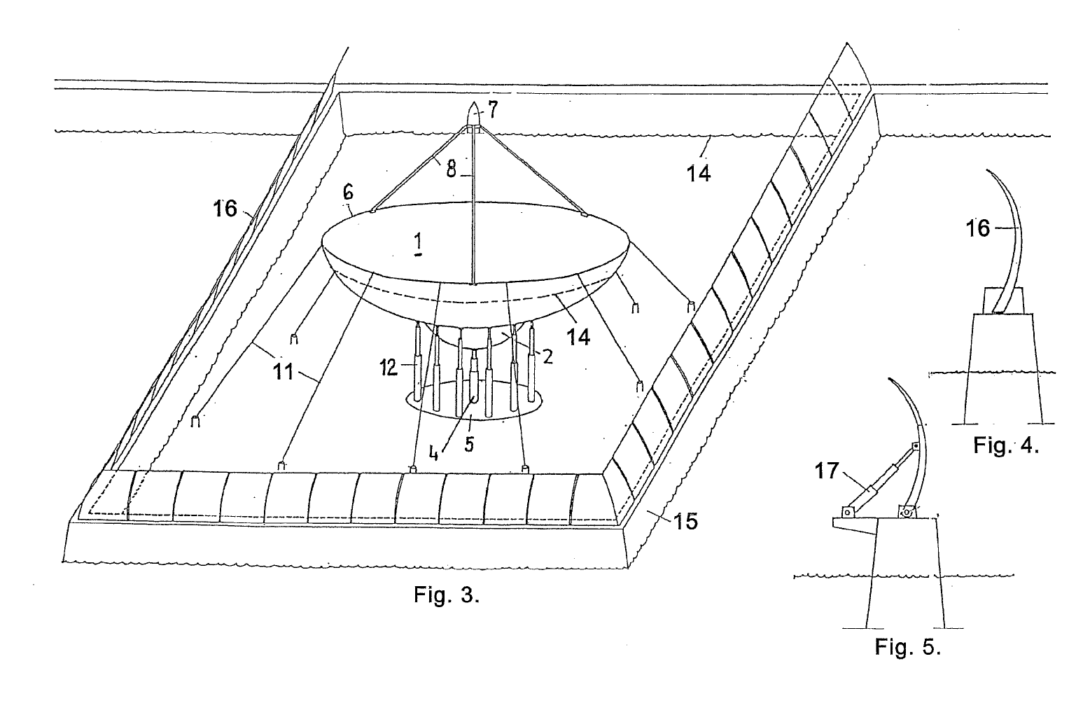

FIG. 3 is a scheme of the equipment according to the invention as settled on water and provided with a barrier,

FIG. 4 is a possible embodiment of the barrier in FIG. 3 provided with fixed, wind baffling elements,

FIG. 5 is another embodiment of the barrier provided with hydraulically moved wind baffling elements,

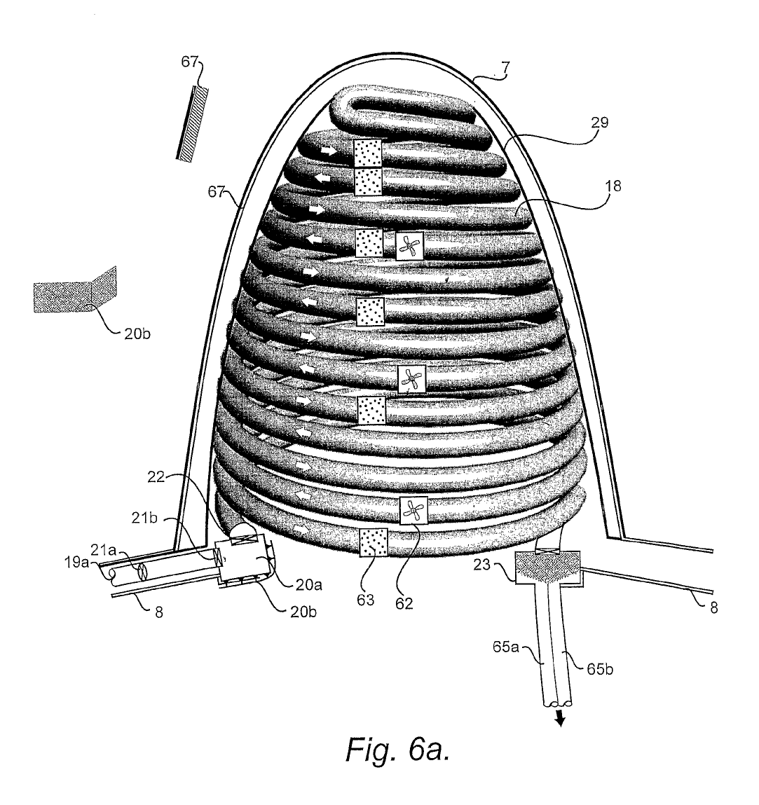

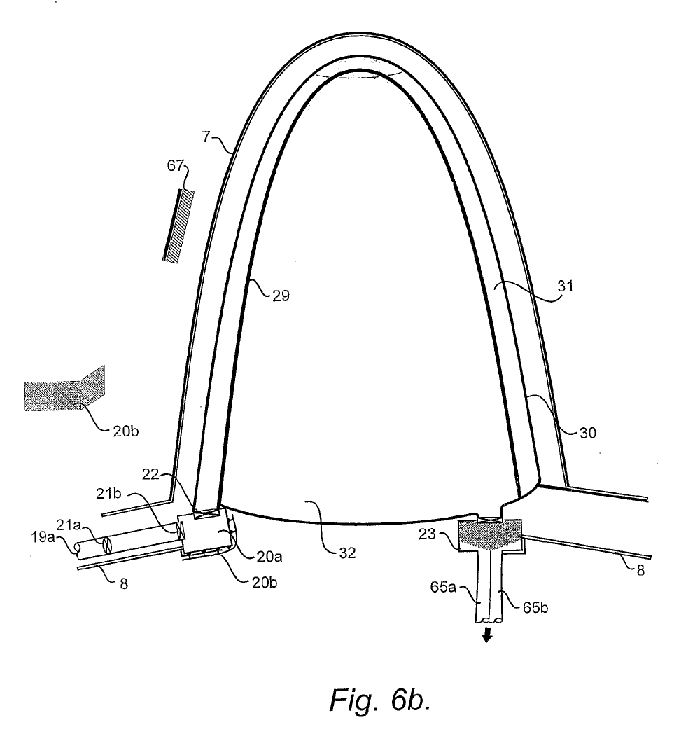

FIG. 6a is the structural scheme of the processing unit in pipe form in the energy receiver,

FIG. 6b shows the conic, cylindrical version of the material processing unit according to the invention,

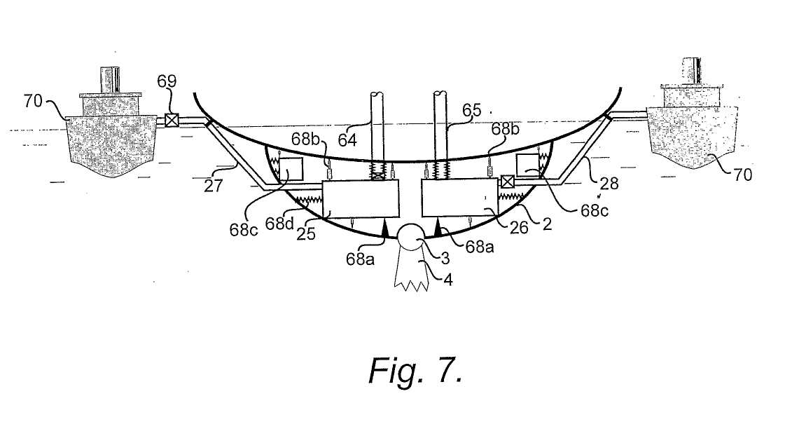

FIG. 7 shows the section of calotte with the storage tanks in it,

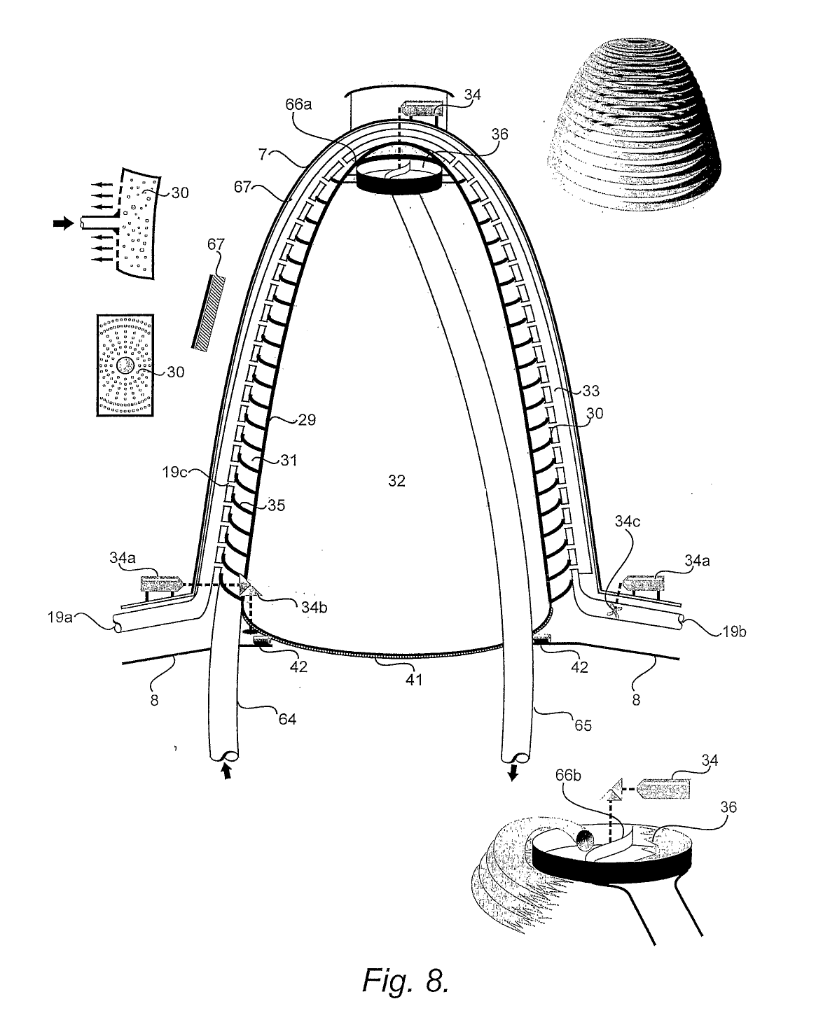

FIG. 8 is one of the embodiments of the material processor as connected to the gas inlet in the energy receiver according to the invention,

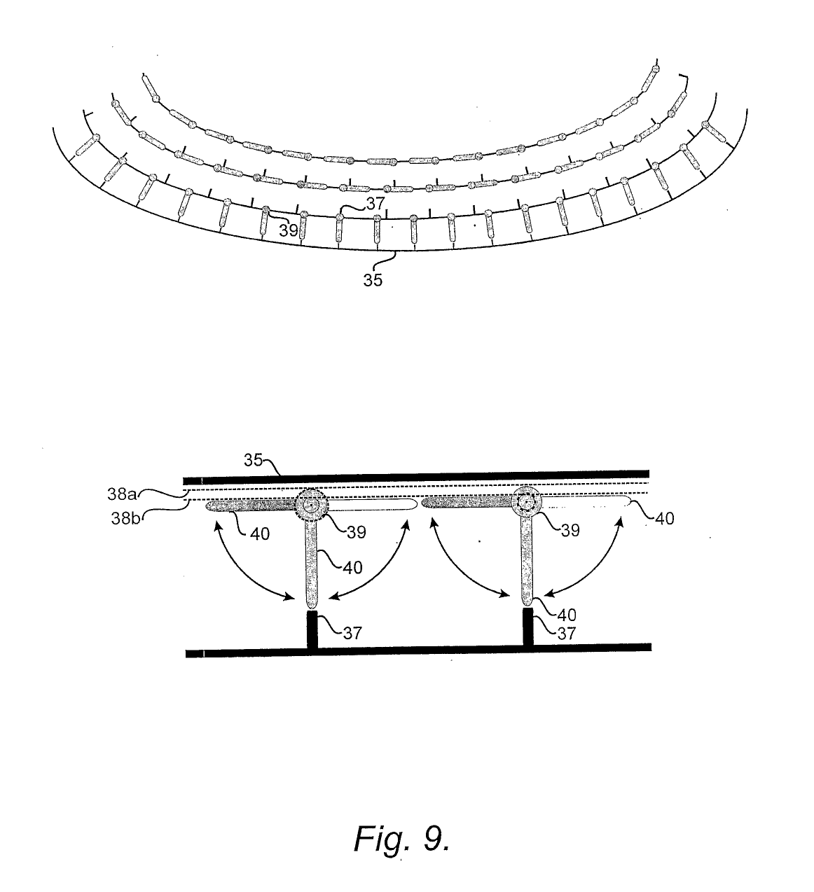

FIG. 9 shows an embodiment of the material transporter in the energy receiver of the equipment according to the invention,

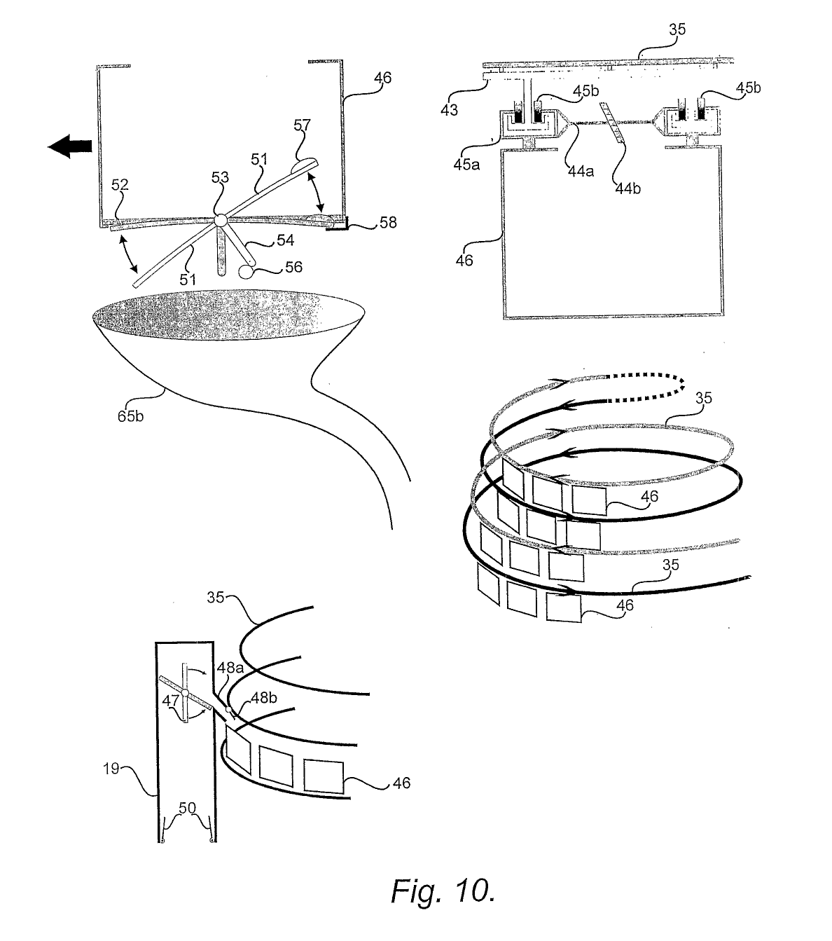

FIG. 10 is a further embodiment of the material transporter in the energy receiver,

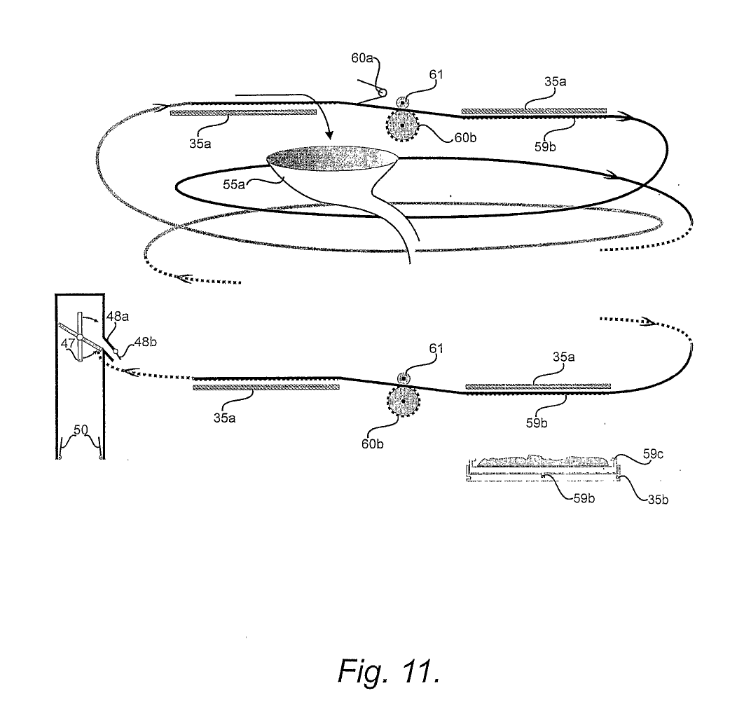

FIG. 11 is an even further embodiment of the material transporter in the energy receiver,

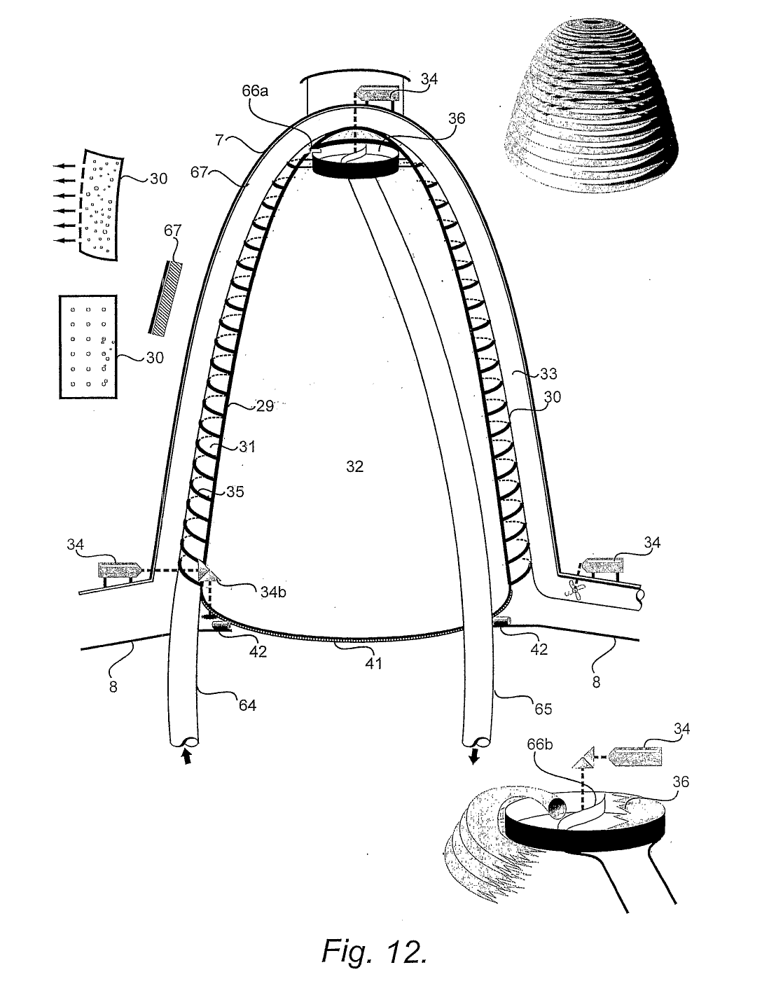

FIG. 12 is a version of the material processor developed in the energy receiver of the collector without a gas inlet,

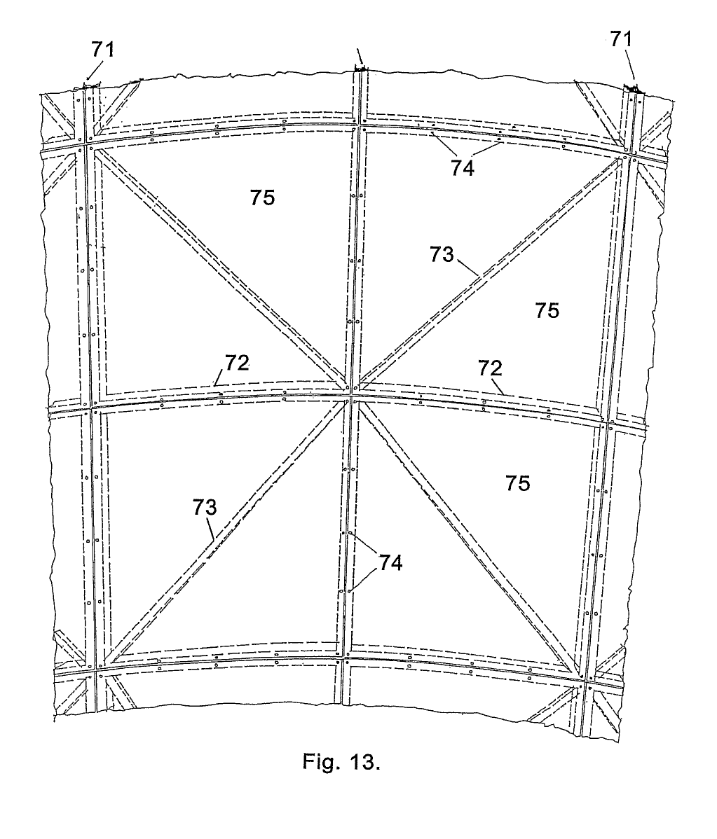

FIG. 13 is the scheme of the internal surface of the collector according to the invention,

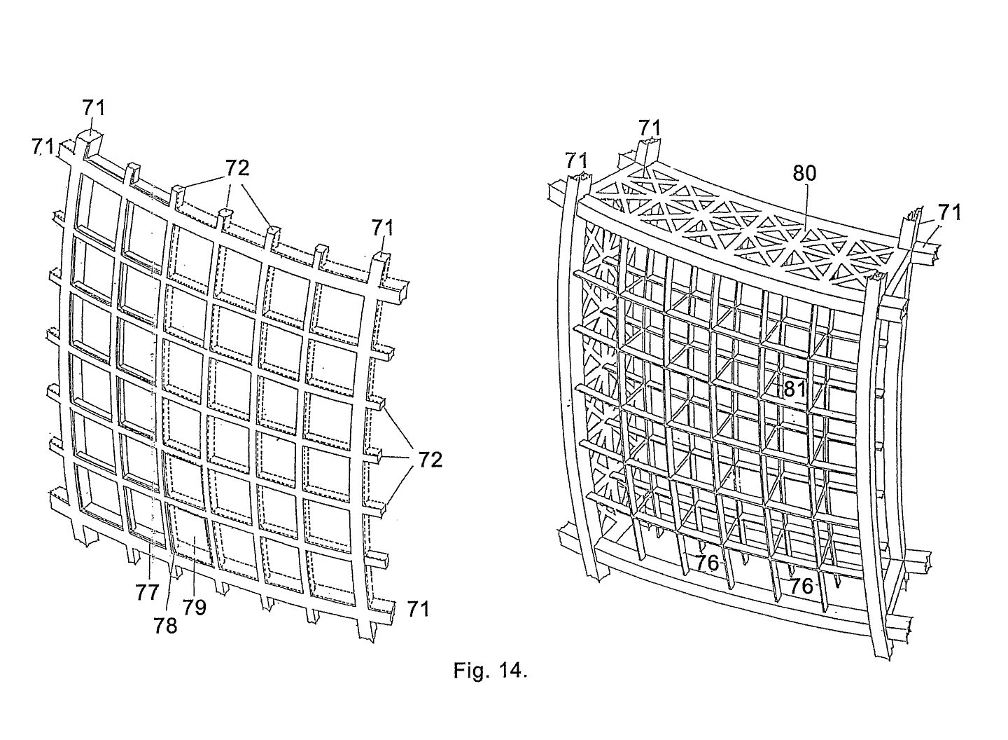

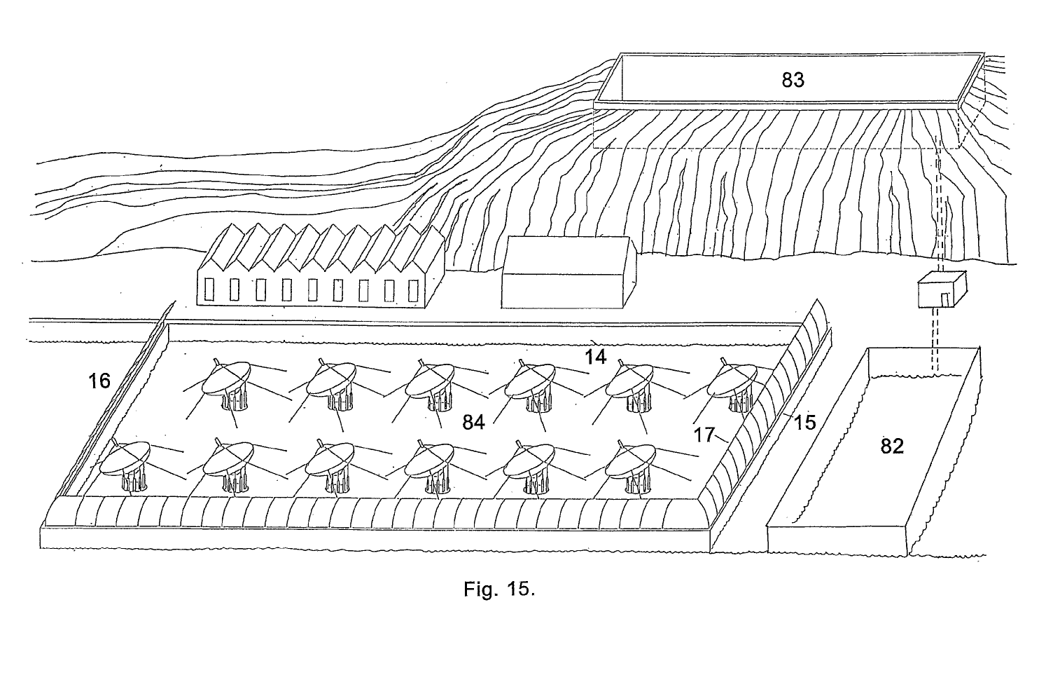

FIG. 14 shows the reinforcing grate structure of the parabolic collector according to the invention, and its rib-frame filled with double-walled, multilayer grate structure,

FIG. 15 illustrates the energy storage equipment of the assistant current generating unit.

FIG. 1 shows the equipment according to the invention when it is settled on water surface, where collector 1 is placed on a water surface 14 of regulated level so that socket 5 is under water level 14, whereas the rim 6 of collector 1 is in every case above the water level. To the reinforced rim 6 of collector 1, stay tackles 11 are fixed operated by a strain structure provided with a regulator. The other end of stay tackles 11 is fixed to socket 9. The hydraulic structures 13 operating main support 4 and telescopic moving structures 12 connected to calotte 2 by ball joint 3 serving for fixing the position of collector 1 are placed onto socket 5 or on a stand above the water surface 14.

According to FIG. 2, collector 1 is provided with air bags 10 at the external western and eastern part containing spaces separated from each other by partition walls.

FIG. 3 shows an embodiment settled on the water surface as an example, where the water surface 14 of regulated level is surrounded by barrier 15 which is provided with sluices and wind baffle elements 16 situated on the barrier. In the embodiment shown in FIG. 4, wind baffle elements 16 are fixed to barrier 5, whereas in the embodiment shown in FIG. 5, they are connected by a telescopic moving element 17. FIG. 3 shows the base position of collector 1, when its rim 6 is in the horizontal plane. This position should be set, when there is a pause in the operation, from sunset to sunrise, or when a smaller storm occurs causing not a too big wind load, not exceeding the given allowed value. Safe protection against tropic cyclons or storms stronger than that is solved by sinking collector 1 under water, which occurs so that the water inlet holes being at the lower, convex part of collector 1 are opened by the regulation, thus due to its own weight, collector 1 sinks under water level 14. After the storm is over, the hydraulic elements lift collector 1 into the suitable height, while water pours out from its internal part. After that, the inlet holes are closed by regulation. The regulated water level of the surface belonging to the solar power station is controlled by instruments, and in case of water level decrease, the level can be restored by opening the sluices, and if necessary, also by pumping.

FIG. 6 shows a material processing system of a pipe-form. According to FIG. 6a, the working space forming a pipeline is in a direct connection with the focused sun rays arriving from the collector, and at its effect, in the pipes moving up- and downwards the required physical or chemical processes take place, then the material processed leaves the receiver and is transferred into the tank in the calotte.

FIG. 6b shows a version of the development of the working space in which the internal, conic heat-receiving wall and another, parallel external wall of a larger diameter enclose a space, to which space a steam generator is connected, into which water is brought by a water transporting pipe going in the internal space of one of the supporting units,which pipe is provided with a pump and a valve. From the steam generator, the water vapor of high pressure gets through a valve into the working space, where the water molecules at the very high temperature decompose thermally. Hydrogen and oxygen thus formed are led into the separator situated at the opposite side to the steam generator, and they are separated and led away on separate pipelines.

In the embodiment shown in FIG. 7, the internal space of calotte 2 is sustained by a stiffening structure. In this sustained space, tanks 25-26 serving for the storage of material to be processed and processed are situated, as well as the heat storing, insulated tank 25a ensuring short time storage of energy. In order to made the storing tanks and their elements independent of the movement of collector 1, tanks 25 and 26 are provided on their one side, above their center of gravity with hydraulically operated telescopes 68, on their other side they are suspended on stiffeners 68b connected to calotte 2 by rigid supporting stand 68a. The tanks are linked to the stiffeners 68a connected to the rib frame of collector 1 by shock absorbers 68b.

Thus the tanks suspended above their center of gravity, and the elements belonging to them are always in the horizontal position. This is ensured in the west-east direction by the suspension, and in the north-south direction by the telescopes. At a quick movement of collector 1, an accidental unsteadyness and resonance of tanks 25-26 are hindered by the shock absorbers. Pipelines leading to and from the tanks are provided with pumps and appropriate heat insulation, and they are partly flexible.

FIG. 8 shows a solution, in which a material processing unit provided with a scroll structure 35 is formed in the energy receiver of collector 1, where via the pipeline 19 situated in the cavity of supporting unit 8 holding receiver 7 gas can be introduced through the branched pipeline linked to pipeline 19 into the working space 31 of the receiver.

FIG. 9 illustrates a material transporting system in which according to another solution, the scroll structure is fixed to the enforced internal wall of the working space in the receptor.

FIG. 10 shows a possible solution of the material transporting system developed in the energy receiver.

FIG. 11 shows another possible solution of material transport by applying a conveyor.

FIG. 12 illustrates the working space of the energy receiver without a gas inlet.

FIG. 13 shows the fashion of the internal surface of collector 1 in the equipment according to the invention. The arched elements needed to building collector 1 are made of multilayers of artificial resin reinforced preferably by textile glass or carbon fiber. The frame structure of collector 1 consists of ribs 71 positioned horizontally and vertically and consisting of rib elements fixed together either by match-joints, or preferably by glueing, or in another way by metal connecting elements surrounding and fixing the ends of individual elements, or by plastic or metal connecting elements making dilatation possible.

The rib frame 72 developed in a net-like way is reinforced by diagonal stiffeners 73. On the concave side of collector 1, on the surface of ribs 71 and rib frames 72, in the vertical direction, borings 74 are made in regular distances. For covering the trapesoidal surface formed by ribs 71 sectioning each other in right angles, on their internal surface, concave reflecting plates 75 of highly efficient reflecting surface and extending until the axis line of ribs 71 and rib frames 72, reinforced preferably by textile glass or carbon fiber are applied, which are fixed by screwed joints to borings 74 in an adjustable way. In another embodiment, the reflecting plates are provided by sun-following tools controlled by a computer.

FIG. 14a shows collector 1 and the arched fields formed by calotte 2, where the trapesoidal surface surrounded by rib elements 71 and 72 is filled up with a multilayered grate-structure 76.

FIG. 14a shows part of the collector formed by the rib frame filled up with a multilayered grate structure. In this embodiment, the internal and external rib frames 72 are connected by distance panels 80, whereas the individual layers of the multilayered grate structure 76 are coupled by connecting elements 81 developed from a tube provided with transversal notches at their end.

According to FIG. 14b, the trapesoidal arched fields of grate structure 76 are provided on their outer side with a water-resistant cover. This cover consists of casette elements 79 insulated by plastic strips 78 glued onto the stick side, which fit into the flanges 77 made on the side of rib frame 72. Casette elements 72 fit into the flanges 77 of rib frame 72, and they are covered by plastic strips 78.

The orientation of the collector according to the invention is ensured by the signals of a central computer pre-programmed by considering the geographical coordinates, days, and the daily schedule, and by those of pairs of photodiodes mounted on the upper rim of the collector looking to the west-east and north-south direction. The photodiodes correct the mistakes originating from eventual inaccuracies of the computer.

The hydraulic system is of a closed cycle type, it is suitable for moving with variable current and direction, synchronously, making slow and fast, gradelessly speed-controlled movements. The most preferable embodiment is working with parallelly coupled work-cylinders of simple operation which are provided with way-changers, and having braking joints. The supporting and moving structures formed by the hydraulic work-cylinders are provided with a water-resistant, clad cover.

The data-storing equipment of the central computer contains a program corresponding to the geographic position, for every day of the year, within the individual days for the starting and finishing phase of operation, in the schedule within the program (section of the day, hour, minute).From this pre-programmed variety, the computer chooses the appropriate one, and starts the service program due in the given day. When needed (e.g. longer lasting cloudy weather, not permanent rain), the automatic control can be changed to manual controlling.

The computer performes also the setting of the parabolic collector into the horizontal base position in case of a higher wind pressure than allowed, of a storm, or in case of a breakdown into the opposite position to that of the sun, and in case of a tropical cyclon or a storm exceeding the allowed wind strength, the sinking of the collector under the water surface and synchronously flooding it by water.

The computer of high efficiency and big storage capacity carries out all the controlling, regulating and checking tasks needed to its automatic operation, ensuring the self-control of the system.

The computer is in connection with a highly accurate clock, wind pressure measuring tool, and other instruments, as well as with all the equipments of the solar power station. There is also a substitute computer for the case the original one breaks down, then it can take over all the controlling tasks automatically.

FIG. 15 shows the positioning of the auxiliary solar power station 84 generating electric current, and the way of its energy storage. This energy storing unit comprises a lower water storing unit 82, its bottom being by one and a half—two meter lower than the highest flood level, and another water storing unit 83 being somewhat higher. These two storing units are necessary, because this arrangement can utilize also the gravitation energy of the level difference between flood and ebb. The water pumped from the lower water storage unit into the upper unit can be drained off into the sea in case of cloudy or not strongly rainy weather through a turbine, and by the current produced by the generator of the power station, processing can be continued in the working space being in the receptor of the sun collector. In addition, the current producing equipment provides also the material processing power stations with the electricity needed to their continuous operation.

Weight reduction originating from the application of light materials brings about other advantages, such as high strength ensured by the fiber reinforcement, dimensional accuracy in the production of elements, and durable binding and corrosion resistance due to the application of glues in the local construction work.

The operation of the solar power station is as follows.

The operation program of the solar power station in daily and yearly sections covering all the details is contained in the storing units of two computers of high efficiency. One of the computers is always in operation, the other one is in reserve. In case of a break-down of the operating computer, the reserve computer takes over its functions.

Before the equipment starts its daily programmed operation, a preparatory work is needed for ensuring continuous, faultless operation. Such a work is e.g. the filling up of the tank or tanks serving for the storage of material to be processed in the calotte of the parabolic collector. Later on, during continuous operation, the discharge of the tank or tanks containing the processed material occurs simultaneously with the filling up of the tank or tanks with the material to be processed.

As the most appropriate time for this is before sunrise or after sunset the parabolic collector being in a horizontal position before starting or after finishing daily work, this occurs always in the early morning or in the evening hours.

During the continuous operation of the equipment—when necessary—filling and emptying of the tanks is also possible at noon, as at that time the parabolic collector stands also in the base, horizontal position, similarly to that at sunset. This filling up takes place so that the pipe stub of the inlet pipe provided with a closing valve or pin of the tank in the calotte serving for storing the material to be processed is connected to the rigid or flexible tube of the pump in the tanker, the valve or pin in the inlet pipe of the tanker is opened, and by starting the pump being in the outlet pipe of the tanker, the tank is filled up with the material to be processed.

In case of continuous operation, simultaneously with filling up the material to be processed, the material already processed is discharged from the storing tank in the calotte in a similar way, only in the opposite direction.

At sunrise, the computer starts the process correspondingly to the daily program by program-control.

After filling up and discharging the tanks in the calotte, and at sunset, program-control starts the operation of the hydraulic and telescopic elements of the parabolic collector, by which the collector is set to the east correspondingly to the daily azimuth of the program for the whole year, then according to the impulses of light diodes and other instruments, it checks the accuracy of the setting, and in need of a correction, it performs this correction. If the reflecting plates are provided with individual moving units, program-control sets these as well. After setting, the program-control in the computer starts the operation according to the daily program.

After that, the computer checks the temperature of the receiver given by data of the temperature-measuring instruments in the receiver, and based on this, it establishes how high a temperature is needed in the working space in order to achieve the working temperature. Then, by utilizing the sun radiation reflected and concentrated from the reflecting surface of the collector, the temperature of the working space is raised to the appropriate value. Simultaneously, the program-control starts to transport the material to be processed into the working space of the receiver by using the material transporting pump. The rate of material transport is regulated by the computer in every case on basis of data of instruments for temperature checking, state-controlling, material transformation, and chemical reaction rate, correspondingly to the heat provided by the heat source and the necessary time determined for processing. Program control works for ensuring the processing of materials and moving the hydraulic, telescopic moving elements of the collector continuously according to its program, as well as it controls the sun-following movement of reflecting plates. Correct setting is checked and if needed, corrected by light diodes and other instruments. In case of a temporary clouding, heat energy can be ensured by the electric energy produced and stored by the current-producing unit, or from the charged heat storage units.

The material transporting structure placed in the working space, transports the material poured onto the lower scroll plate of the scroll system by rotating the structure, or by a two-dimensional movement of the blade ensuring uniform spreading and transport of the material into the tank placed in the upper part of the conic body. In this way, the material being at the very high temperature required reacts with carbon dioxide formed or introduced, and the oxide material is reduced. In case of a conveyor, this introduction occurs at the lowest part of the conveyor, which transports the material after processing to the tank in the upper part of conic material processing unit. When using a container for material transport, filling up of the container being at the lowest level occurs from the buffer tank of the ascending pipe. Containers pour the processed material thus transported into the capacious upper part of the descending pipe. In a working space made of a helical pipe coil, input of the material takes place directly from the ascending pipeline, then, after making its whole way, from the end of helical pipe coil, the material gets into the descending pipeline. Simultaneously to this, removal of the gases and vapors formed is also performed. In kinds of processing in which the material should only be burnt out, this occurs continuously and simultaneously with the removal of gases and vapors.

The speed of material transport is in the majority of cases the same, and it is synchronous with the transport speed in the ascending pipeline. An exception is when the speed of material in the ascending pipeline should be changed in function of the amount of heat available and the correspondingly longer or shorter processing time. This is also regulated by the computer program control. One of the most important rules is that the material to be processed should not leave the working space, until the chemical reaction is fully finished. This is checked by the instruments in the receiver, and according to data coming from there, program control directs processing correspondingly to requirements.

Material processed and transported by the material transporting system into the storage tank in the upper part of receiver or directly to the descending pipeline gets via the descending pipe into the storage tank in the calotte serving for storing the material processed. From there, by transporting via a pump, it gets into the tank of the tanker in early morning, at noon or after sunset.

In the embodiment where a gas should be applied for assisting chemical reactions in processing (e.g. carbon monoxide formed from anthracyte or introduced for reducing of the material to be processed), in one of the solutions this gas is led into the working space via the branched pipelines and their branchings in the supporting structure. The gas introduced has not only the role of a reducing agent assisting thereby the reaction, but by creating a fluid state through the flotation of the small particles, the reaction rate is increased as well. The porous structure of the wall of the working space allows the gases to flow into the space between the internal wall of the jacket covering the receiver and the external wall of the working space, where they can be removed via a pipe being in the supporting unit and an outlet at the opposite side to their introduction by operating a ventilator driven by an external engine, descending on the external rim of the parabolic collector, through a flexible pipe into a tank settled on the water surface. This tank is provided with an instrument for reducing carbon dioxide to carbon monoxide, which is then can be led back into the working space. Thereby is the gas cycle closed.

In another embodiment, in which there is no need to introduce a gas for processing, no gas pipeline is to be found, however, gas removing structures already described are also necessary with the difference that the storage tank is provided with instruments needed to the neutralization of gases corresponding to their composition.

In cases when metal oxides melt in the processing working space, the external wall of this working space—except for material transport by containers—is not porous, and the removal of gases occurs through the outlet holes at the most upper part of the working space, or via gas separating structures.

In case of a temporary clouding, industrial operation is ensured by solar power stations formed from one or more solar power plants producing electric current or heat, which are preferably utilizing Brayton's gas cycle or containing traditional electric current producing or heat storing equipments.

1. Solar power station for processing various materials by solar energy with a parabolic collector provided in its focus with a receiver, fixed in a manner enabling its free rotation at least in two directions around the shaft at its convex side, of a double shell structure comprising arched segments clamped to a grated frame structure adjustable to follow the direction of sunshine, provided with supporting and moving elements where it contains a heat receiver developed as a processing working space, and is connected to material storing units characterized in that the conic receiver (7) of the collector (1) comprises a conic internal cavity the wall of which and the parallel external wall of the receiver (7) enclose another internal cavity furnished with material transporting structures, and serves as a processing working space for processing various materials by heat energy, further one of the material storing units (25) of the calotte (2) belonging to the collector (1) is connected by an ascending pipeline (64) provided with a pump to the material processing working space (31) in the receiver (7) of the collector (1), and from this working space another, descending pipeline (65) leads into another material storing tank (26) placed in the calotte (2).

2. The solar power station according to claim 1 characterized in that there are telescopic elements (12) distributed uniformly along the annulus in the parallel plane with the rim (6) of the collector (1) in the supporting-moving structures, at the other end of which they are coupled to a socket (5) in a way rotable in every direction, and they surround a telescopic main supporter (4) supporting the collector (1) unilinearly with its rotation axis by a ball joint, and fixed with its lower end to the socket (5).

3. The solar power station according to claim 2 characterized in that the telescopic elements (12) and the telescopic main supporter (4) are of hydraulic operation.

4. The solar power station according to claim 2 characterized in that at the external surface of the collector (1) being in axial symmetry with it, another body of rotation, preferably a hemisphere or a calotte (2) of a smaller surface than the former is developed, further in the space enclosed by the collector (1) and the calotte (2) a stiffening structure (68a) is placed whereas the telescopic main supporter (4) is connected to the calotte (2) and to the collector (1) in a common axis line.

5. The solar power station according to claim 2 characterized in that the telescopic main supporter (4) and the telescopic elements (12) are provided with a hydraulic control unit (13) connected to the electronic control unit.

6. The solar power station according to claim 1 characterized in that the collector (1) is settled onto a water surface (14) of regulated level so that the socket (5) is under water level (14), whereas the run of the collector (1) is always above the water level, and the telescopic moving elements (12) and the telescopic main supporter (4) are covered by a sleeved, water-resistant mantle.

7. The solar power station according to claim 1 characterized in that the limiting wall (26) of the internal cavity in the receiver (7) collecting the heat energy reflected from the reflecting surface of the collector (1) is made of a metal of high melting point or of some ceramics, and the internal side of the external wall (7a) of the receiver (7) is provided with a highly efficient insulation (67).

8. The solar power station according to claim 1 characterized in that the limiting wall (29) of the internal cavity in the receiver (7) and the porous wall (30) parallel to the former and being permeable to gases and vapors enclose a space, and in this space as processing space (31), an ascendent scroll unit as a material transporting unit (35) is developed which is provided with vertically fixed scroll plates (37) in the cross direction in appropriate distances for hindering the sliding of the material, and which is fixed to the lowest, vertical scroll plate of the scroll system (35) coupled to an annulus (41) provided with a toothing at its external side, which annulus (41) rotates together with the material transporting scroll system (35) driven by a cogwheel (34a) connected to an external electric engine (34) on bearings (42) being on the internal side of the supporting structure (8) of the receiver (7).

8b. (canceled)

9. The solar power station according to claim 8 characterized in that in the internal part of the supporting unit (8) of the receiver (7) a pipeline (19a) is situated, which pipeline in the closed space enclosed by the external wall (30) of the working space of the receiver (7) and the external wall of the receiver (7) branches into pipes of ever decreasing diameters is connected by inlet pipes (19b) to the external, porous wall (30) of the working space, and serves for the introduction of gases promoting chemical reactions.

10. The solar power station according to claim 6 characterized in that there is a tank (25) for storing the material to be processed in the calotte (2), from which an ascending pipeline (64) provided with a pump (21a) and leading to the receiver (7) is connected to the working space via a hole made into the bottom of the working space, and close to the upper part of the material transporting scroll plate (35) having the smallest diameter, a collecting tank (34) is fixed to the external part of the internal wall limiting the cavity in the receiver for receiving the incoming material from the uppermost scroll plate (35), and to a hole at the bottom of this collecting tank (34) a descending material transporting pipeline is connected coupling thereby the collecting tank with the storing tank for the processed material in the calotte (2).

11. The solar power station according to claim 7 characterized in that the working space (31) of the receiver (7) is without a gas inlet, and the removal of gases and vapors formed from the closed space (33) between the external wall (30) of the working space and the external wall of the receiver (7) occurs via the hole made on the bottom of this space, and the connecting pipe (19c) led in the internal part of the supporting unit (8) of the receiver through the operation of a ventilator (34c), which pipeline (19b) leads along the rim of the collector (1) from the supporting structure (8) by a flexible pipe into a tank provided with a regenerating unit and situated above the water level.

12. The solar power station according to claim 1 characterized in that the sroll system (35) in the working space (31) of the receiver (7) is fixed to the reinforced internal wall of the working space (31) of the receiver (7), and to the lower surface of the scroll plate, rail structures (41) are fixed which support and transport the material transporting containers (46) by wheels (45) coupled to the supporting structure (45b) by means of a tooth chain (44b) linked to connecting chains (44b), and at a higher level than the lowest scroll plate, a buffer tank (47) is situated on the upper part of the ascending material transporting pipeline (19a), which is filled up by opening the swing door (49) rotating around an axis in the middle line of the bottom of the tank (47), and the closing plate (48b) of the outlet opening (48a) of which buffer tank (47) is opened or closed by the program control unit by means of the pulse of a built in photo electric cell, and the bottom plate (51) of the material transporting containers (46) are supported by an axis (53) in the geometrical middle of the bottom plate (51), and on which axis (53) serving for the rotation of the bottom plate (51), at its lower part a lever (51) going vertically downwards and being of a definite length is fixed, at the bottom of the working space, above a descending transporting pipeline (65b) having a capacious space, a horizontal lever (54) is fixed to the internal wall of the working space, into which the vertical lever (51) serving for the rotation of the bottom plate impinges when the container (46) moves, and shifts it horizontally opening thereby the bottom plate (51) of the container (46), and after emptying the container, the bottom plate (51) is closed by gravitation due to a counterweight (57) on the opposite side or to a spring, a further sinking of the bottom plate of the container and an undesirable opening thereby is hindered by a bolt (58) on the lower part of the container on the side of the counterweight.

13. The solar power station according to claim 1 characterized in that the upper, reinforced part of the ascending material transporting pipe (64) leading to the receiver (7) from the storing tank (25) in the calotte (2) fitting tight to the external wall (30) of the internal cavity of the receiver (7) forming a pipe coil (18a) ascending helically, in which pipe coil (18a) the moving of material is performed by specific pumps or blades (62), and this pipe coil developed as a working space is provided with a flap valve (22) or by a gas separating unit for the removal of the gases formed, and the removal of the material processed is solved either through a collecting tank coupled to the descending material transporting pipe (65) developed in the conical working space, or by an opposite, even-uneven construction of the pipe coil, in which case the lowest end of the pipe coil is connected to the material transporting pipe (65).

14. The solar power station according to claim 1 characterized in that on the external side of the wall (30) limiting the internal cavity of the receiver, a helically ascending pipe coil (18) adhering to the wall and to each other, designed for high pressure and made of a metal of high strength and high melting point, and at the lower part of this pipe coil (18) a steam generator (20a) are situated, to the steam generator (20a) the water transporting pipe (19a) provided with a pump (21a) and being in the supporting unit (8) is connected through a valve (21b), and from which steam generator (20a) the hot steam of high pressure gets into the pipe coil (18), where, being in an overheated state, it is thermally decomposed, and the hydrogen and oxygen evolved is separated by the separator (23) at the lower part of the pipe coil, and then they are led separately via pipelines (65a-65b) into the tanks (25-26) in the calotte (2).

15. The solar power station according to claim 1 characterized in that the limiting wall (29) of the internal cavity in the receiver (7) and the closed external wall (30) of the working space parallel to it form a cylindrical space closed from above and at its bottom, the limiting walls (18b) of which are made of a metal of high strength and melting point, and the lower part of this cylindrical space (18b) contains a steam generator (20), to which steam generator a water transporting pipeline (19a) is linked provided with a valve and a pump being in the supporting unit of the receiver, and from the steam generator (20a) furnished with a heat transferring surface (20b), the hot vapor of high pressure gets to the cylindrical body (18b) through a valve (22), the lower part of which contains the separator (23) for separating the hydrogen and oxygen formed from the overheated water vapor by thermal decomposition, and they are led via the separate pipelines (65a-65b) into the tanks (25-26) in the calotte (2).

16. The solar power station according to claim 7 characterized in that to the internal wall (30) of the receiver (7) a scroll structure (35) is fixed, at the sides of which a notch is made, in which notch the flexible conveyor at the upper surface of the scroll plate progresses by fixed lugs provided with rolls, and in a trough in the middle line of the lower part of the conveyor a rack (60a) is developed, which rack is driven by a cogwheel (60b) connected to an electric engine in an interrupted part of the upmost scroll plate, where a collecting tank is situated for receiving the material coming from the conveyor, and above the cogwheel, a wheel without toothing (61) and rotating freely around an axis is to be found for assisting the adhesion of the cogwheel, which cogwheel (60b) deflects the conveyor from the upper surface of the the highest end of the scroll system to the lower surface of the opposite, descending scroll plate, to the notch developed there, and the deflection of the conveyor from the lowest scroll plate occurs in the opposite way, when from the lower part of the descending scroll plate the cogwheel (60b) deflects the conveyor to the upper surface of the opposite scroll plate.

17. The solar power station according to claim 1 characterized in that from the tank (25) serving for the storage of the material to be processed situated in the calotte (2), a rigid pipeline (27) leads to above the water level (14) by breaking through the wall of the calotte (2), at the end of which pipeline a closing valve or phi and a pipe connecting structure is to be found linked to the outlet pipe provided with a pump of the tanker arriving at the site, while the tank (26) in the calotte (2) storing the material processed and furnished with a pump at the end of its rigid outlet pipe (28) is also provided with a valve or pin, and a pipe connecting unit by which it is linked to the inlet pipe of the tanker just arriving.

18. The solar power station according to claim 1 characterized in that in the internal wall (29) of the working space hi the receiver (7) limiting the cavity or fixed to this wall, an electric heating is placed for case of temporary clouding or short-term raining.

19. The solar power station according to claim 1 characterized in that the shape of the processing working space (31) developed in the receiver (7) of the equipment according to the invention makes the processing of various materials by means of high temperature or by some chemical reactions, or by the combination of both possible, especially the indirect or direct production of hydrogen by thermal decomposition, production of alumina or aluminum, burning out the raw materials of cement production, and production of metals from their ores.

20. The solar power station according to claim 1 characterized in that the collector (1) on its outer side, from the east and west, is provided with air bags (10) divided by partition walls into separate spaces.

21. The solar power station according to claim 1 characterized in that the regulated water level (14) is surrounded with a barrier (15) provided with sluices, and with wind baffling elements on it, where these wind baffling elements are connected to the barrier (15) either in a rigid way (16), or by pins and a telescopic moving element (17).

22. The solar power station according to claim 1 characterized in that several parabolic sun collectors (1) are settled onto the regulated level of the water surface (14) surrounded by the barrier (15) provided with sluices.

23. The solar power station according to claim 1 characterized in that in case of a solar power station, a lower water reservoir (82) is situated in a depth being under the flood level, and an upper water reservoir (83) is placed above the natural water level, connected to each other by a pipeline provided with pumps, turbines and generators, as well as with outlet pipes.

24. The solar power station according to claim 16 characterized in that the energy transforming system consists of air-compressing, preheating, heating and turbogenerator units.

25. The solar power station according to claim 1 characterized in that the equipment serves for the utilization of solar energy by a parabolic collector provided with a receiver in its focus, and with a moving structure for following sunshine comprising arched segments clamped into a grated frame structure of double-shell structure, fixed in a manner enabling its free rotation around a shaft at least in two directions at its convex side, provided with supporting-moving elements and instruments for measuring the direction of sunshine and wind pressure, in which the receiver comprises a heat accepting unit, which, in turn, contains a processing and collecting unit for the processing of various materials by solar energy, further instruments for measuring and controlling the temperature, observing and controlling material transport, measuring the pressure, monitoring and controlling chemical reactions, as well as other instruments and control units needed for a faultless operation, and the collector (1) is made of arched fields (71) comprising double, arched segments where the inner and outer rib frames are connected by distance panels (80), and the space enclosed by the double, arched ribs (71) and the distance panels (80) is filled up with a fixed, multilayer grate structure (76) the layers being connected to each other by connecting elements (81).

26. Equipment according to claim 25 characterized in that the grate structure (76) is closed from its outside by casette elements (79) fixed to the ribs (71) and to the rim (77) of the grate structure (76), and the sides of the casette elements (79) and the surfaces of connecting elements are closed by flexible plastic strips (78) provided on their one side with some glue material.

27. The solar power station according to claim 25 characterized in that the casette elements (79) are made of artificial resins reinforced by carbon fibers or textile glass and they are fixed to the connecting elements preferably by glueing.

28. The solar power station according to claim 1 characterized in that the collector (1) is covered on its inside by reflecting plates (75) directed to the focus of the collector, which are preferably made of some artificial resin reinforced by carbon fiber or textile glass, and in the internal surface of the collector (1) the ribs (71) are reinforced by stiffeners (73), and they are fixed through the borings (74) on the ribs (71) by adjustable spring screw fastening, or are provided with computer-controlled sun-following moving elements.

29. The solar power station according to claim 1 characterized in that there are rotably fixed blades (40) on the axis (39) fixed to the external wall (29) limiting the internal cavity of the receiver for the uniform distribution and material transport, which blades are connected into series, ratable in two directions, moved by wire ropes (38a and 38b) in appropriate distances above the scroll plates, being on the material transporting structure (35) fixed to the wall (29) limiting the internal cavity of the receiver (7).
